(19) United States
(12) Patent Application Publication
(10) Pub. No.: US 2019/0342609 A1
(43) Pub. Date: Nov. 7, 2019

(54) TRANSMISSION CONTROL APPARATUS, RECEPTION CONTROL APPARATUS, AND TRANSCEIVING CONTROL SYSTEM

(71) Applicant: SONY SEMICONDUCTOR SOLUTIONS CORPORATION, KANAGAWA (JP)

(72) Inventors: ATSUSHI MORI, KANAGAWA (JP); TOSHIHISA HYAKUDAI, KANAGAWA (JP)

(21) Appl. No.: 16/475,449

(22) PCT Filed: Oct. 11, 2017
(86) PCT No.: PCT/JP2017/036736

§ 371 Date: Jul. 2, 2019

(30) Foreign Application Priority Data
Jan. 16, 2017 (JP) 2017-004986

(51) Int. Cl. H04N 21/4425; H04N 21/436; H04N 17/00; H04N 21/442

(52) U.S. Cl. CPC H04N 21/4425; H04N 21/44209; H04N 17/004; H04N 21/436

(57) ABSTRACT

It is desired that a technology is provided that can further suppress disturbance of a video displayed on a reception side even if a transmittance state of a lane in which a part or whole of a video signal is transmitted among the plurality of lanes is deteriorated. Provided is a transmission control apparatus including: a first transmittance frame generation unit that generates a first transmittance frame transmitted via a first lane on the basis of a first divided signal obtained through division of a video signal; an insertion unit that inserts restoration data based on at least a part of the first divided signal into a second divided signal obtained through division of the video signal; and a second transmittance frame generation unit that generates a second transmittance frame transmitted via a second lane that is different from the first lane on the basis of the second divided signal into which the restoration data has been inserted.

### TECHNICAL FIELD

The present disclosure relates to a transmission control apparatus, a reception control apparatus, and a transceiving control system.

### BACKGROUND ART

In recent years, as a technology for transmitting a video signal using a plurality of lanes, high-definition multimedia interface (HDMI), Display Port (hereinafter simply the “DP”), or the like has been known. In the HDMI, pixel data is assigned to any of the plurality of lanes for each piece of color information, and the pixel data is transmitted on the basis of the assignment of the lane with regard to color information. Meanwhile, in the DP, pixel data is assigned to any of the plurality of lanes, and the pixel data is transmitted on the basis of the assignment of the lane with regard to the pixel data.

In a case where a certain lane has failure in transmittance of a video signal in the HDMI and the DP, the color information becomes not normal in a reception apparatus or pixel data that is not displayed occurs. Then, ultimately, image output is stopped in the reception apparatus, and processing, e.g., black screen output, may be performed.

In order to avoid the occurrence of such a situation, a technology that performs transmittance of a video signal by each of a plurality of transmittance methods has been disclosed (see, for example, Patent Document 1). With such a technology, even if malfunction occurs in data transmittance by a certain transmittance method, the certain transmittance method is complemented by a different transmittance method such that data to be received by the certain transmittance method can be restored by data received by the different transmittance method.

### CITATION LIST

### PATENT DOCUMENT

Patent Document 1: Japanese Patent Application Laid-Open No. 2012-245107

### SUMMARY OF THE INVENTION

### Problems to be Solved by the Invention

However, it is desired that a technology is provided that can further suppress disturbance of a video displayed on a reception side even if a transmittance state of a lane in which a part or whole of the video signal is transmitted among the plurality of lanes is deteriorated.

### Solutions to Problems

According to the present disclosure, there is provided a transmission control apparatus including: a first transmittance frame generation unit that generates a first transmittance frame transmitted via a first lane on the basis of a first divided signal obtained through division of a video signal; an insertion unit that inserts restoration data based on at least a part of the first divided signal into a second divided signal obtained through division of the video signal; and a second transmittance frame generation unit that generates a second transmittance frame transmitted via a second lane that is different from the first lane on the basis of the second divided signal into which the restoration data has been inserted.

According to the present disclosure, there is provided a reception control apparatus including: a signal acquisition unit that, in a case where a first transmittance frame including a first divided signal obtained through division of a video signal is transmitted via a first lane, and a second transmittance frame including a second divided signal into which restoration data based on at least a part of the first divided signal has been inserted is received via a second lane that is different from the first lane, acquires the second divided signal into which the restoration data has been inserted from the second transmittance frame.

According to the present disclosure, there is provided a transceiving control system including: a transmission control apparatus including: a first transmittance frame generation unit that generates a first transmittance frame transmitted via a first lane on the basis of a first divided signal obtained through division of a video signal, an insertion unit that inserts restoration data based on at least a part of the first divided signal into a second divided signal obtained through division of the video signal, and a second transmittance frame generation unit that generates a second transmittance frame transmitted via a second lane that is different from the first lane on the basis of the second divided signal into which the restoration data has been inserted; and a reception control apparatus including: a signal acquisition unit that acquires the second divided signal into which the restoration data has been inserted from the second transmittance frame.

### Effects of the Invention

According to the present disclosure described above, a technology is provided that can further suppress disturbance of a video displayed on a reception side even if a transmittance state of a lane in which a part or whole of the video signal is transmitted among the plurality of lanes is deteriorated. Note that the effects described above are not necessarily limitative. With or in place of the above effects, there may be achieved any one of the effects described in this specification or other effects that may be grasped from this specification.

### BRIEF DESCRIPTION OF DRAWINGS

FIG. 1 is a diagram illustrating an example of a configuration of a signal transmittance system according to a first embodiment.

FIG. 2 is a diagram illustrating an example of a detailed configuration of a duplication insertion unit according to the first embodiment.

FIG. 3 is a diagram illustrating an example of a detailed configuration of a transmittance frame transmission unit according to the first embodiment.

FIG. 4 is a diagram illustrating an example of a detailed configuration of a transmittance frame reception unit according to the first embodiment.

FIG. 5 is a diagram illustrating an example of a detailed configuration of an extraction selection unit according to the first embodiment.

FIG. 6 is a diagram illustrating a configuration example of a video frame included in a video signal.

FIG. 7 is a diagram illustrating a transmittance data example of each lane in a case where sub-data is duplication data.

FIG. 8A is a diagram illustrating an example in which transmittance data of each lane in a case where sub-data is duplication data is applied to the DP.

FIG. 8B is a diagram illustrating an example in which transmittance data of each lane in a case where sub-data is duplication data is applied to the DP.

FIG. 9A is a diagram illustrating an example in which transmittance data of each lane in a case where sub-data is duplication data is applied to the HDMI.

FIG. 9B is a diagram illustrating an example in which transmittance data of each lane in a case where sub-data is duplication data is applied to the HDMI.

FIG. 9C is a diagram illustrating an example in which transmittance data of each lane in a case where sub-data is duplication data is applied to the HDMI.

FIG. 10 is a diagram illustrating a first example of transmittance data of each lane in a case where the amount of data of sub-data is smaller than the amount of data of main data.

FIG. 11 is a diagram illustrating a second example of transmittance data of each lane in a case where the amount of data of sub-data is smaller than the amount of data of main data.

FIG. 12 is a diagram illustrating a third example of transmittance data of each lane in a case where the amount of data of sub-data is smaller than the amount of data of main data.

FIG. 13 is a diagram illustrating an example of a configuration of a signal transmittance system according to a second embodiment.

FIG. 14 is a diagram illustrating a configuration example of a duplication insertion unit according to the second embodiment.

FIG. 15 is a diagram illustrating a configuration example of an extraction selection unit according to the second embodiment.

FIG. 16 is a diagram illustrating a transmittance data example of each lane in a case where sub-data is difference data.

### MODE FOR CARRYING OUT THE INVENTION

Preferred embodiments of the present disclosure will be described in detail below with reference to the accompanying drawings. Note that, in this specification and the drawings, configuration elements that have substantially the same function and configuration are denoted with the same symbols, and repeated description is omitted.

Furthermore, in this specification and the drawings, multiple configuration elements that have substantially the same function and configuration are denoted with the same symbols followed by different numerals to be distinguished. However, in a case where there is no need in particular to distinguish respective configuration elements and the like that have substantially the same function and configuration, the same symbol alone is attached. Furthermore, similar configuration elements in a different embodiment are distinguished by being designated with different alphabets after the same symbol.

Note that, description is given in the order described below.

0. Overview

1. First embodiment

1.1 Configuration of signal transmittance system

1.2. Configuration of transmission apparatus

1.3. Configuration of reception apparatus

1.4. Description of operation

1.5. Description of effect

2. Second embodiment

2.1 Configuration of signal transmittance system

2.2. Configuration of transmission apparatus

2.3. Configuration of reception apparatus

2.4. Description of operation

2.5. Description of effect

3. Conclusion

### 0. Overview

First, an overview of the present embodiment is described. In recent years, as a technology for transmitting a video signal using a plurality of lanes, HDMI, DP, or the like has been known. In the HDMI, pixel data is assigned to any of the plurality of lanes for each piece of color information, and the pixel data is transmitted on the basis of the assignment of the lane with regard to color information. Meanwhile, in the DP, a coordinate is assigned to any of the plurality of lanes, and the pixel data is transmitted on the basis of the assignment of the lane with regard to the coordinate.

In a case where a certain lane has failure in transmittance of a video signal in the HDMI and the DP, the color information becomes not normal in a reception apparatus or pixel data that is not displayed occurs. Then, ultimately, image output is stopped in the reception apparatus, and processing, e.g., black screen output, may be performed.

In order to avoid the occurrence of such a situation, a technology that performs transmittance of a video signal by each of a plurality of transmittance methods has been disclosed (see, for example, Japanese Patent Application Laid-Open No. 2012-245107). With such a technology, even if malfunction occurs in data transmittance by a certain transmittance method, the certain transmittance method is complemented by a different transmittance method such that data to be received by the certain transmittance method can be restored by data received by the different transmittance method.

However, such a technology is based on the assumption that a video signal is transmitted by a plurality of transmittance methods and does not take into account restoration of data in a case where a video signal is transmitted by a single transmittance method. Furthermore, in such a technology, error determination is performed in units of video streams. Therefore, even if data is transmitted in a duplicate manner by the same transmittance method, when an error occurs in each transmittance lane of a duplicate source and a duplicate destination of the same video stream, video output becomes difficult.

Furthermore, the HDMI has a Pixel Repetition function for transmitting data in a duplicate manner. In the Pixel Repetition function, the same data is repeatedly transmitted in a single lane. Therefore, in a case where a certain lane has failure, all pieces of data to be repeatedly transmitted in the certain lane are not transmitted normally. Accordingly, data that is repeatedly transmitted in a fault lane cannot be used for restoration of data of the lane.

Thus, the present specification mainly describes a technology that can further suppress disturbance of a video displayed on a reception side even if a transmittance state of a lane in which a part or whole of the video signal is transmitted among the plurality of lanes is deteriorated.

Heretofore, the overview of the present embodiment has been described.

### 1. First Embodiment

Next, the first embodiment is described.

(1-1. Configuration of Signal Transmittance System)

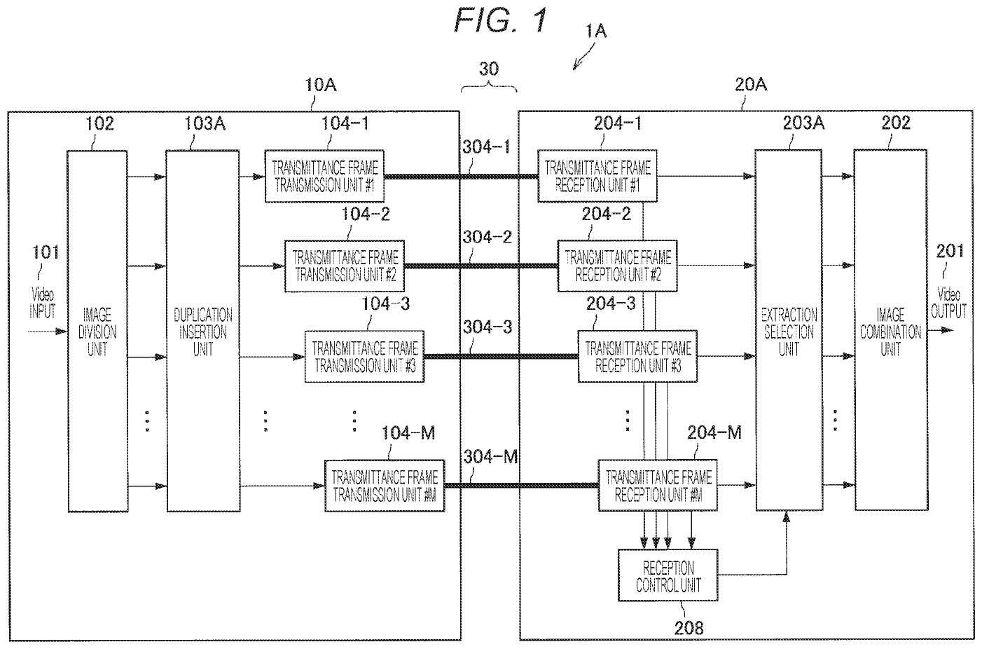

First, a configuration example of a signal transmittance system 1A according to the first embodiment is described. FIG. 1 is a diagram illustrating an example of a configuration of the signal transmittance system 1A according to the first embodiment. As illustrated in FIG. 1, the signal transmittance system 1A includes a transmission apparatus 10A and a reception apparatus 20A. Furthermore, the transmission apparatus 10A and the reception apparatus 20A are connected via a transmittance path 30.

Note that, in the present specification, description is mainly given of an example in which a video signal is treated as a transmission signal from the transmission apparatus 10A to the reception apparatus 20A. Furthermore, in the present specification, description is mainly given of an example in which the transmission signal is transmitted by an optical signal. However, the transmission signal may be transceived by a different signal, e.g., an electric signal, not by an optical signal. The transmission apparatus 10A can function as a “transmission control apparatus.” Furthermore, the reception apparatus 20A can function as a “reception control apparatus.” The signal transmittance system 1A can function as a “transceiving control system.”

(1-2. Configuration of Transmission Apparatus)

Next, a configuration of the transmission apparatus 10A according to the first embodiment is described. The transmission apparatus 10A divides a video signal into a plurality of signals (hereinafter also called the “divided signals”), and transmits a plurality of divided signals on the basis of assignment of lane with respect to each of the plurality of divided signals. Note that, as will be described later, the video signal may be transmitted without being divided into a plurality of divided signals by the transmission apparatus 10A. The video signal 101 is input to the transmission apparatus 10A. The video signal 101 includes a plurality of video frames (images) in a chronological order. Furthermore, as illustrated in FIG. 1, the transmission apparatus 10A includes an image division unit 102, a duplication insertion unit 103A, and transmittance frame transmission units 104-1 to 104-M.

The image division unit 102 divides the video signal and obtains a plurality of divided signals. The maximum number of divisions may be M (M is an integer of two or more), which is the number of lanes 304. In the present embodiment, description is mainly given of an example in which all of the M-number of lanes 304 are used for transmission of the video signal. However, only some of them may be used for transmission of the video signal (free lanes may be present). Furthermore, in the present embodiment, description is mainly given of a case in which the video signal is divided in units of coordinate. However, the unit of division is not limited to a coordinate unit, but may be a block unit including a plurality of coordinates. Each of divided signals #1 to #M is output to the image division unit 102.

The duplication insertion unit 103A assigns the divided signal #1 as main data to a corresponding lane 304-1, and inserts restoration data based on at least some of the other divided signals #2 to #M as sub-data into the divided signal #1 of the lane 304-1. Similarly, the duplication insertion unit 103A assigns each of the divided signals #2 to #M as main data to a corresponding lane (lanes 304-2 to 304-M), and inserts restoration data based on at least some of other divided signals as sub-data into each of the divided signals #2 to #M.

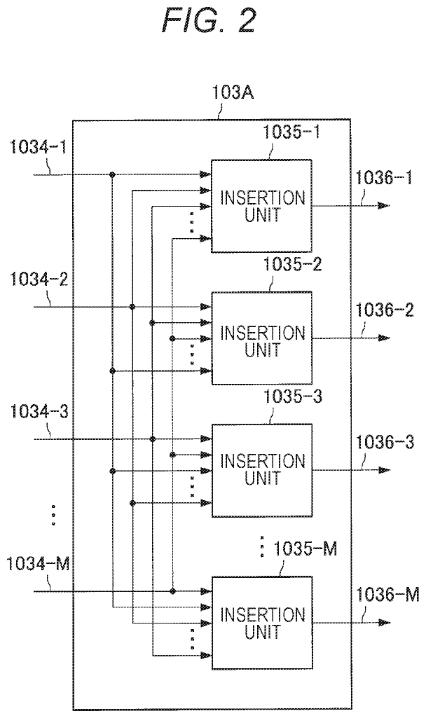

FIG. 2 is a diagram illustrating an example of a detailed configuration of the duplication insertion unit 103A according to the first embodiment. As illustrated in FIG. 2, the duplication insertion unit 103A includes insertion units 1035-1 to 1035-M. The divided signal #1 is input to the insertion unit 1035-1 from an input port 1034-1. Similarly, corresponding divided signals (divided signals #2 to #M) are input to the insertion units 1035-2 to 1035-M from corresponding input ports (input ports 1034-2 to 1034-M).

The insertion unit 1035-1 assigns the divided signal #1 input from the input port 1034-1 to the lane 304-1 as main data, and inserts restoration data based on at least some of the other divided signals #2 to #M as sub-data. As an example, the insertion unit 1035-1 treats the divided signal #1 input from the input port 1034-1 as main data, and inserts the duplication data with respect to a part or all of the divided signals #2 to #M input from the input ports 1034-2 to 1034-M into the main data as sub-data.

Similarly, the insertion units 1035-2 to 1035-M treat the divided signals (divided signals #2 to #M) input from the corresponding input ports (input ports 1034-2 to 1034-M) as main data, and insert duplication data with regard to a part or all of the other divided signals into the main data as sub-data.

An example of insertion of the sub-data into the main data will be described later in detail. The main data into which the sub-data has been inserted (hereinafter also called the “composite data”) by the insertion unit 1035-1 is output to a corresponding transmittance frame transmission unit 104-1 from an output port 1036-1. Similarly, the composite data is output from the insertion units 1035-2 to 1035-M to corresponding transmittance frame transmission units (transmittance frame transmission units 104-2 to 104-M) via corresponding output ports (output ports 1036-2 to 1036-M).

Referring back to FIG. 1, description is continued. The transmittance frame transmission unit 104-1 generates a transmittance frame on the basis of the composite data input from the duplication insertion unit 103A. Then, the transmittance frame transmission unit 104-1 transmits the generated transmittance frame to the lane 304-1, which is linked to itself. Similarly, each of the transmittance frame transmission units 104-2 to 104-M generates a transmittance frame on the basis of the composite data input from the duplication insertion unit 103A, and transmits the generated transmittance frame to a lane (lanes 304-2 to 304-M), which is linked to itself.

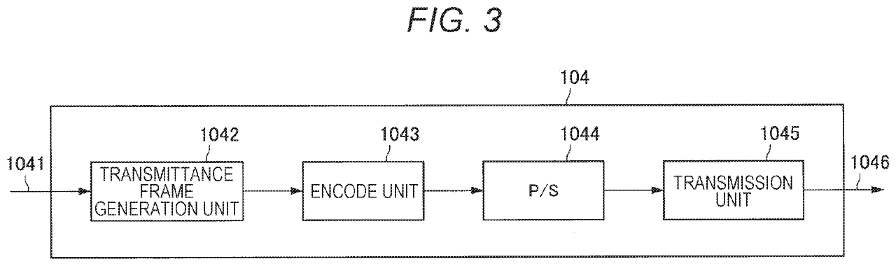

FIG. 3 is a diagram illustrating an example of a detailed configuration of the transmittance frame transmission unit 104 according to the first embodiment. As illustrated in FIG. 3, an input port 1041 is a port into which the composite data is input. The transmittance frame transmission unit 104 includes a transmittance frame generation unit 1042, an encode unit 1043, P/S (parallel-serial conversion unit) 1044, and a transmission unit 1045. Functions of these functional blocks are described below.

The transmittance frame generation unit 1042 frames the composite data and generates a transmittance frame when the composite data is input from the input port 1041. Framing may be done in any way. For example, the transmittance frame generation unit 1042 may perform framing by attaching a frame start identifier, which indicates the head of the transmittance frame, to the composite data.

Any one of predetermined codes not present at least in the video signal (hereinafter also called the “special data”) is assigned to the frame start identifier. For example, the special data depends on encoding of data that is transceived with respect to the lane 304. For example, in a case where ANSI 8b/10b conversion is used for encoding of data that is transceived with respect to the lane 304, K code may be assigned to the special data. For example, data in which K code (0xBC) continues for N bytes, which is called K28.5, may be assigned to the frame start identifier.

The encode unit 1043 performs encoding on the composite data. Specifically, the encode unit 1043 performs 8b/10b encoding on the composite data. At this time, the encode unit 1043 may replace the frame start identifier with corresponding special data and replace data other than the frame start identifier with 10-bit unit data within the composite data.

The P/S 1044 converts parallel data into serial data in order to set the encoded composite data into a form suitable for high speed transmittance.

The transmission unit 1045 transmits the transmittance frame. The transmittance frame is output from an output terminal 1046. For example, the transmission unit 1045 includes an LDD (laser diode driver) and an LD (laser diode). The LDD drives the LD, and the LD outputs the transmittance frame, which is input from the LDD, from the output terminal 1046. Note that, the present embodiment assumes the case in which the lane 304 includes an optical fiber and the LD converts the transmittance frame into an optical signal and then transmits the optical signal to the reception apparatus 20A. However, the type of signal of the transmittance frame is not limited. For example, the transmission apparatus 10A may transmit the transmittance frame to the reception apparatus 20A by an electric signal.

Referring back to FIG. 1, description is continued. The transmittance path 30 includes lanes 304-1 to 304-M (M is an integer of two or more). Here, the number of lanes 304 is indicated by M, but the number of lanes 304 is not particularly limited insofar as the number is plural.

(1-3. Configuration of Reception Apparatus)

Next, a configuration of the reception apparatus 20A according to the first embodiment is described. The reception apparatus 20A receives a plurality of pieces of composite data from the lanes 304-1 to 304-M and generates the video signal on the basis of the plurality of pieces of received composite data. As illustrated in FIG. 1, the reception apparatus 20A includes transmittance frame reception units 204-1 to 204-M, an extraction selection unit 203A, an image combination unit 202, and a reception control unit 208. Each of the transmittance frame reception units 204-1 to 204-M is linked to a corresponding lane (lanes 304-1 to 304-M).

Accordingly, the transmittance frame reception unit 204-1 receives the transmittance frame from the lane 304-1 and acquires the composite data from the received transmittance frame. Similarly, each of the transmittance frame reception units 204-2 to 204-M also receives the transmittance frame from a corresponding lane (lanes 304-2 to 304-M) and acquires corresponding composite data from the received transmittance frame.

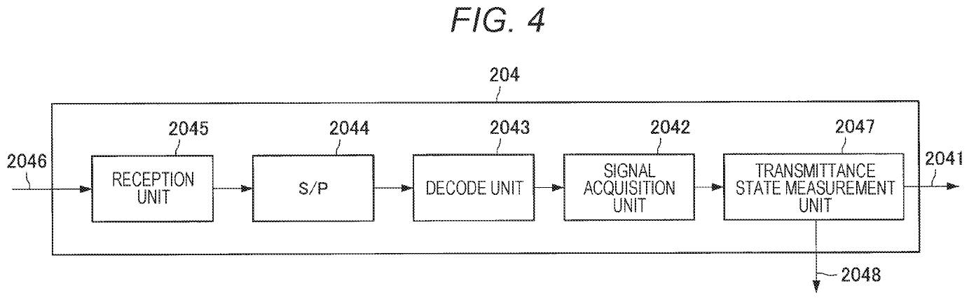

FIG. 4 is a diagram illustrating an example of a detailed configuration of the transmittance frame reception unit 204 according to the first embodiment. An input port 2046 is a port to which the transmittance frame is input. The transmittance frame input from the input port 2046 is input to the transmittance frame reception unit 204. The transmittance frame reception unit 204 includes a reception unit 2045, an S/P (serial-parallel conversion unit) 2044, a decode unit 2043, a signal acquisition unit 2042, and a transmittance state measurement unit 2047. Here, functions of these functional blocks are described.

The reception unit 2045, when the transmittance frame transmitted from the transmission apparatus 10A is input from the input port 2046 via the lane 304, receives the transmittance frame. The reception unit 2045 includes a PD (photodetector) and an amplifier.

The PD receives the transmittance frame transmitted from the transmission apparatus 10A by an optical signal and converts the transmittance frame into an electric signal. Note that, the present embodiment assumes the case in which the lane 304 includes an optical fiber and the PD receives the transmittance frame and converts the transmittance frame into an electric signal. However, as described above, the type of signal transmitted from the transmission apparatus 10A to the reception apparatus 20A is not limited. For example, the reception apparatus 20A may receive the transmittance frame from the transmission apparatus 10A by an electric signal.

The amplifier amplifies the transmittance frame, which is an electric signal output from the PD, and outputs the amplified transmittance frame to the S/P 2044. For example, after a voltage signal is obtained through impedance conversion on a current signal, the amplifier may perform amplitude amplification on the voltage signal. The S/P 2044 converts the form of transmittance frame from serial data into parallel data.

The decode unit 2043 decodes the transmittance frame, which has been converted into parallel data. Specifically, the decode unit 2043 may perform 8b/10b decoding on the transmittance frame. For example, the decode unit 2043 may replace 10-bit special data corresponding to the frame start identifier with the frame start identifier within the transmittance frame. Meanwhile, the decode unit 2043 may also replace the remaining data with 8-bit data within the transmittance frame.

The signal acquisition unit 2042, because the transmittance frame to be input is framed, obtains decoded data by cancelling the framing. In more details, the signal acquisition unit 2042 detects the position of the frame start identifier given in place of the special code, as the position of the head of the transmittance frame. The signal acquisition unit 2042 obtains decoded data on the basis of the position of the frame start identifier. The composite data obtained by the signal acquisition unit 2042 is output to the transmittance state measurement unit 2047.

The transmittance state measurement unit 2047 measures the transmittance state of the corresponding lane. The transmittance state of lane may be measured in any way. For example, the transmittance state measurement unit 2047, in a case where parity data for error detection is added to the transmittance frame, may measure whether or not the transmittance state of lane is better or worse than a predetermined state depending on whether or not the parity data for error detection added to the transmittance is correct.

Alternatively, the transmittance state measurement unit 2047 may measure whether or not the transmittance state of lane is better or worse than the predetermined state depending on whether or not the code after the 8b/10b decoding is a used code (whether or not the code is present in a code table). Alternatively, the transmittance state measurement unit 2047 may measure whether or not the transmittance state of lane is better or worse than the predetermined state depending on whether or not a TERC code of the received transmittance frame is a used code (whether or not the code is present in the code table).

Results of the measurement of the transmittance state measured by the transmittance state measurement unit 2047 are output to the reception control unit 208 from an output port 2048. Meanwhile, the composite data input to the transmittance state measurement unit 2047 is output to the extraction selection unit 203A from an input port 2041.

Referring back to FIG. 1, description is continued. The reception control unit 208 makes a determination as to which of the main data (divided signal #1) and its sub-data to select within the composite data received by the transmittance frame reception unit 204-1 on the basis of the results of the measurement of the transmittance state output from the transmittance frame reception unit 204-1. Then, the reception control unit 208 controls (outputs a control signal) selection of one of the main data (divided signal #1) and its sub-data by the extraction selection unit 203A on the basis of the determination result.

Similarly, the reception control unit 208 makes a determination as to which of the main data (divided signals #2 to #M) and its sub-data to select within the received composite data on the basis of the results of the measurement of the transmittance state output from the transmittance frame reception units 204-2 to 204-M. Then, the reception control unit 208 controls (outputs a control signal) selection of one of the main data (divided signals #2 to #M) and its sub-data by the extraction selection unit 203A on the basis of the determination result.

The extraction selection unit 203A extracts the main data (divided signal #1) and its sub-data from the composite data acquired in the transmittance frame reception unit 204-1, and selects one of the main data (divided signal #1) and its sub-data according to the control by the reception control unit 208. Similarly, the extraction selection unit 203A extracts the main data (divided signals #2 to #M) and its sub-data from the composite data acquired in the transmittance frame reception units 204-2 to 204-M, and selects one of the main data (divided signals #2 to #M) and its sub-data according to the control by the reception control unit 208.

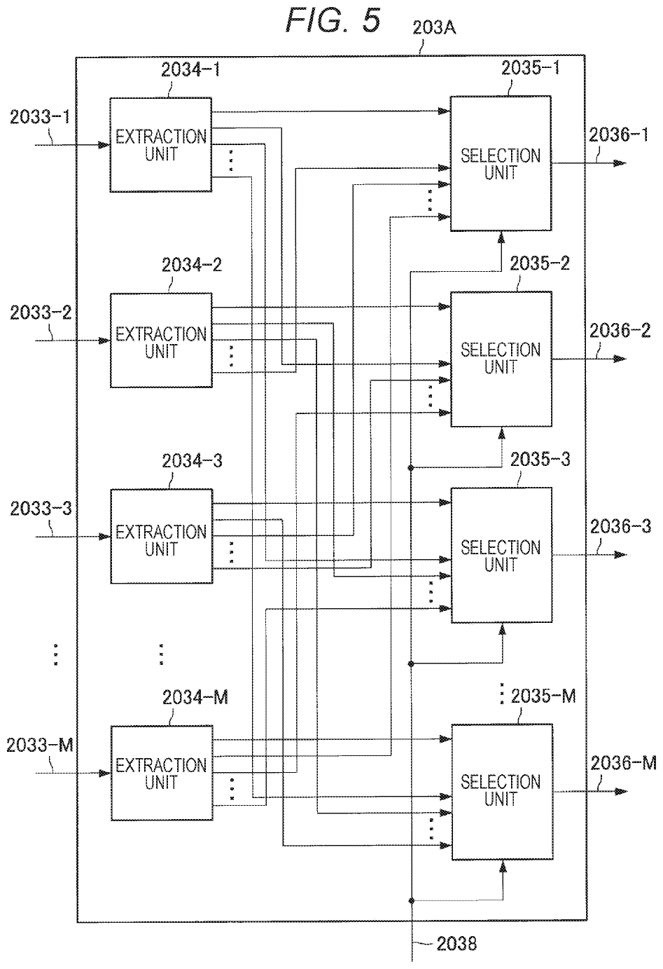

FIG. 5 is a diagram illustrating an example of a detailed configuration of the extraction selection unit 203A according to the first embodiment. An input port 2033-1 is a port to which the composite data acquired in the transmittance frame reception unit 204-1 is input. The composite data input from the input port 2033-1 is input to an extraction unit 2034-1. Similarly, input ports 2033-2 to 2033-M are ports to which the composite data acquired in corresponding transmittance frame reception units (transmittance frame reception units 204-2 to 204-M) is input. The composite data input from the input ports 2033-2 to 2033-M is input to corresponding extraction units (extraction units 2034-2 to 2034-M).

The extraction unit 2034-1 extracts the main data and the sub-data from the composite data input from the input port 2033-1. As an example, the main data extracted by the extraction unit 2034-1 may be the divided signal #1 (divided signal input from the input port 1034-1). The sub-data extracted by the extraction unit 2034-1 may be some or all of the divided signals #2 to #M (divided signals input from the input ports 1034-2 to 1034-M).

Similarly, the main data extracted by each of the extraction units 2034-2 to 2034-M may be corresponding divided signals (divided signals #2 to #M, i.e., divided signals input from the input ports 1034-2 to 1034-M). The sub-data extracted by each of the extraction units 2034-2 to 2034-M may be some or all of the other divided signals.

The selection unit 2035-1 selects one of the main data (divided signal #1) extracted by the extraction unit 2034-1 and the sub-data (some or all of the divided signals #2 to #M) extracted by each of the other extraction units (extraction units 2034-2 to 2034-M) on the basis of the control information input from the reception control unit 208 via an input port 2038. The data selected by the selection unit 2035-1 is output to the image combination unit 202 from an output port 2036-1.

Similarly, each of the selection units 2035-2 to 2035-M selects one of the main data (divided signals #2 to #M) extracted by a corresponding extraction unit (extraction units 2034-2 to 2034-M) and the sub-data extracted by each of the other extraction units on the basis of the control information input from the reception control unit 208 via the input port 2038. The data selected by each of the selection units 2035-2 to 2035-M is output from corresponding output ports (output ports 2036-2 to 2036-M).

As an example, it is sufficient if the selection unit 2035-1 selects the main data (divided signal #1) in a case where the transmittance state of a lane #1 is better than a predetermined state. Meanwhile, it is sufficient if the selection unit 2035-1 selects the sub-data (some or all of the divided signals #2 to #M) in a case where the transmittance state of the lane #1 is worse than the predetermined state. It is sufficient if such selection is made according to control by the reception control unit 208.

Similarly, it is sufficient if the selection units 2035-2 to 2035-M select the main data in a case where the transmittance state of corresponding lanes (lanes #2 to #M) is better than the predetermined state. Meanwhile, it is sufficient if the selection units 2035-2 to 2035-M select the sub-data in a case where the transmittance state of corresponding lanes (lanes #2 to #M) is worse than the predetermined state. It is sufficient if such selection is also made according to control by the reception control unit 208.

Referring back to FIG. 1, description is continued. The image combination unit 202 generates a -video signal by combining pieces of the main data (or sub-data) output from the transmittance frame reception units 204-1 to 204-4. In other words, the image combination unit 202 corresponds to the image division unit 102 of the transmission apparatus 10A.

The above description is mainly based on the assumption of the case in which the duplication insertion unit 103A assigns the divided signal #1 as the main data to the corresponding lane 304-1, and inserts restoration data based on at least some of all the other divided signals #2 to #M as the sub-data into the divided signal #1 of the lane 304-1. However, the sub-data inserted into the main data (divided signal #1) may be restoration data based on at least a part of some of the other divided signals.

For example, the sub-data inserted into the main data (divided signal #1) may be restoration data based on at least some of the divided signal #2 of one type. In contrast, the sub-data inserted into the main data (divided signal #2) may be restoration data based on at least some of the divided signal #1 of one type. As in the present example, two lanes out of the lanes 304-1 to 304-M may be combined, and the sub-data inserted into the main data of one lane may be restoration data based on at least some of the divided signals of the other lane of the combination.

In this way, in a case where the sub-data is the divided signal of one type, divided signals of two types: main data and sub-data are output to a corresponding selection unit (2035-1 to 2035-M) from the extraction units 2034-1 to 2034-M of the extraction selection unit 203A. Then, each of the selection units 2035-1 to 2035-M of the extraction selection unit 203A selects the divided signal of one type from the divided signals of two types: main data and sub-data.

(1-4. Description of Operation)

As described above, the case is assumed in which two lanes out of the lanes 304-1 to 304-M are combined, and the sub-data inserted into the main data of one lane is restoration data based on at least some of the divided signals of the other lane of the combination. In such a case, description is given of an example of the operation of the signal transmittance system 1A according to the first embodiment of the present disclosure with attention being drawn to the lane 304-1 (lane #1) and the lane 304-2 (lane #2), which make a combination.

First, the case is assumed in which the transmittance state of the lane 304-1 is worse than the predetermined state. In such a case, the transmittance state measurement unit 2047-1 of the transmittance frame reception unit 204-1 detects that the transmittance state of the lane 304-1 is worse than the predetermined state, and results of the measurement of the transmittance state of the lane 304-1 are output from the output port 2048. The reception control unit 208, when detecting that the transmittance state of the lane 304-1 is worse than the predetermined state on the basis of the measurement result, controls the selection unit 2035-1 to select the sub-data extracted by the extraction unit 2034-2.

The selection unit 2035-1 selects the sub-data extracted by the extraction unit 2034-2 according to control by the reception control unit 208. As a result, instead of the lane #1 in which the transmittance state is worse than the predetermined state, the divided signal #1 transmitted as the sub-data in the lane #2 in which the transmittance state is better than the predetermined state is output to the image combination unit 202 via the output port 2036-1. Accordingly, disturbance due to deterioration of the transmittance state is suppressed in the video signal generated by the image combination unit 202. Next, description is given of a configuration example of a video frame included in the video signal.

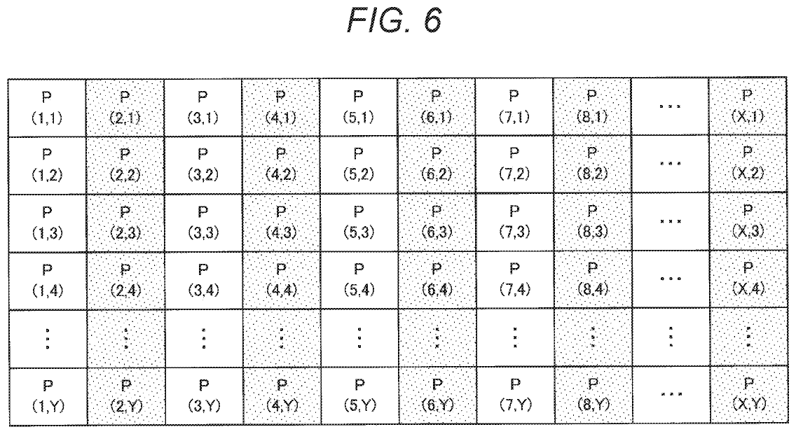

FIG. 6 is a diagram illustrating a configuration example of a video frame included in a video signal. As illustrated in FIG. 6, the video frame constitutes a rectangular shape in which X-number pixel data is arranged in a horizontal direction and Y-number pixel data is arranged in a vertical direction. Accordingly, pixel data is present corresponding to each coordinate of the video frame. For example, P(4,5) indicates pixel data in which X coordinate is “4” and Y coordinate is “5.” For example, pixel data includes color information, e.g., RGB or YCbCr. The case is assumed below in which pixel data having an odd number in the X coordinate and pixel data having an even number in the X coordinate are transmitted in different lanes.

As an example, duplication data with respect to some or all of the main data (divided signal #1) transmitted in the lane #1 may be inserted into the main data (divided signal #2) transmitted in the lane #2. Meanwhile, duplication data with respect to some or all of the main data (divided signal #2) transmitted in the lane #2 may be inserted into the main data (divided signal #1) transmitted in the lane #1. Description is mainly given below of an example of data (main data and sub-data) transmitted in the lane #1 and the lane #2.

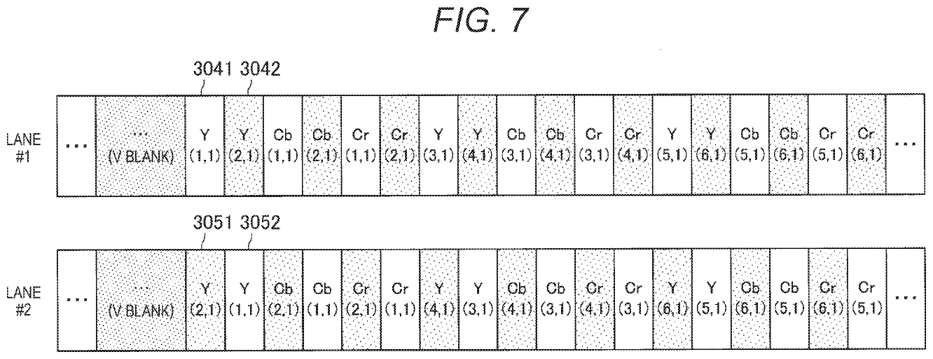

FIG. 7 is a diagram illustrating a transmittance data example of each lane in a case where the sub-data is duplication data. As illustrated in FIG. 7, each of a plurality of pieces of pixel data constituting the main data (divided signal #1) transmitted in the lane #1 includes three elements: YCbCr. Furthermore, each of plurality of pieces of pixel data constituting the main data (divided signal #2) transmitted in the lane #2 includes three elements: YCbCr.

For example, the insertion unit 1035-1 may insert the element of the main data (divided signal #2) transmitted in the lane #2 as the sub-data following each element of the main data (divided signal #1) transmitted in the lane #1. Similarly, the insertion unit 1035-2 may insert the element of the main data (divided signal #1) transmitted in the lane #1 as the sub-data following each element of the main data (divided signal #2) transmitted in the lane #2.

Referring to FIG. 7, Y information 3041 of Pixel(1,1) is transmitted as the main data in the lane #1, and Y information 3051 of Pixel(2,1) is transmitted as the main data in the lane #2. Thereafter, Y information 3042 of Pixel(2,1) is transmitted as the sub-data in the lane #1, and Y information 3052 of Pixel(1,1) is transmitted as the sub-data in the lane #2.

As in the present example, immediately after the element of the main data (divided signal #1) is transmitted in the lane #1, the element may be transmitted as the sub-data in the lane #2. Then, immediately after the element of the main data (divided signal #2) is transmitted in the lane #2, the element may be transmitted as the sub-data in the lane #1. In this way, the amount of buffer required for insertion and extraction of the main data and the sub-data can be reduced, and transmittance delay time of the main data and the sub-data is reduced. However, the order of transmission of the main data and the sub-data is not limited.

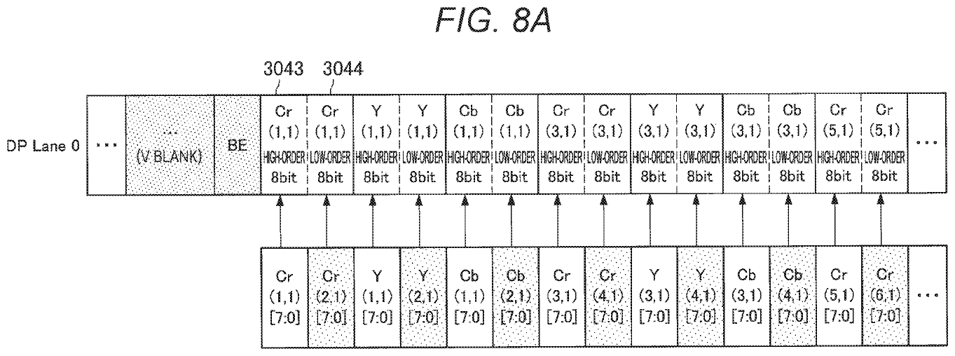

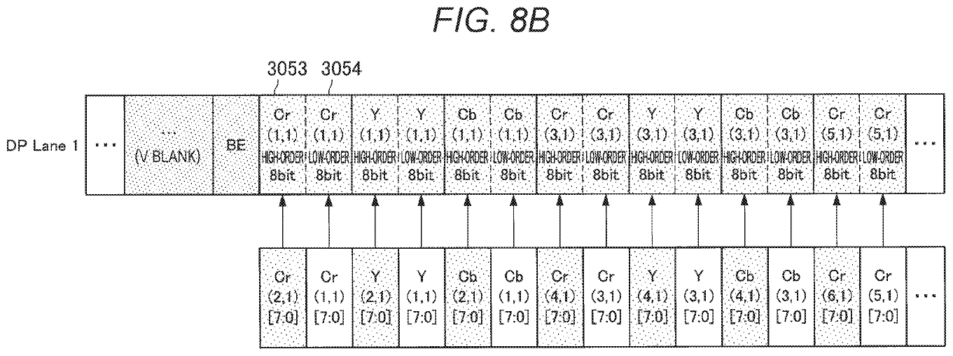

FIGS. 8A and 8B are diagrams illustrating an example in which transmittance data of each lane in a case where sub-data is duplication data is applied to the DP. In the present example, in the DP, data transmittance is performed at 16-bit Color Depth on the transmittance path. In practice, data transmittance is performed at 8-bit Color Depth. High-order 8 bits of the 16-bit data are treated as the main data, and low-order 8 bits are treated as the sub-data. In the DP, in a case where 16-bit data transmittance is performed, after V blank and BE packet, the elements are transmitted in order of Cr, Y, and Cb such that high-order 8 bits of each element are first and low-order 8 bits of each element are later.

In FIG. 8A, in original DP standards, in a DP Lane 0, high-order 8 bits 3043 of Cr information of Pixel(1,1) are transmitted and then low-order 8 bits 3044 of the Cr information are transmitted. However, in the present embodiment, the 8-bit Cr information of Pixel(1,1) is transmitted as the main data and then the 8-bit Cr information of Pixel(2,1) transmitted in the DP Lane 1 is transmitted as the sub-data.

Furthermore, as illustrated in FIG. 8B, in the present embodiment, similarly in the DP Lane 1, instead of the high-order 8 bits 3053 of the Cr information of Pixel(2,1), the 8-bit Cr information of Pixel(2,1) is transmitted as the main data. Furthermore, in the present embodiment, instead of the low-order 8 bits 3054 of the Cr information of Pixel(2,1), the 8-bit Cr information of Pixel(1,1) transmitted in the DP Lane 0 is transmitted as the sub-data.

Note that such data transmittance can be achieved such that in the signal transmittance system 1A illustrated in FIG. 1, in a case where the transmission apparatus 10A is a DP transmitter and the reception apparatus 20A is a DP receiver, a video signal 101 (video input) and the image division unit 102 are operated corresponding to Color Depth 8 bits of the DP, 8-bit sub-data is inserted into 8-bit main data to form 16-bit data in the duplication insertion unit 103A, the transmittance frame transmission units 104-1 to 104-M, the lanes 304-1 to 304-M, and the transmittance frame reception units 204-1 to 204-M are operated corresponding to Color Depth 16 bits of the DP, 8 bits are extracted from the 16-bit data in the extraction selection unit 203A, and the image combination unit 202 is operated corresponding to Color Depth 8 bits of the DP.

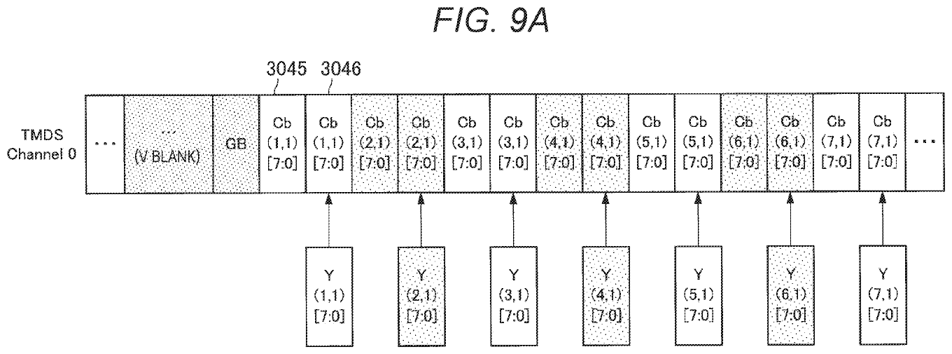

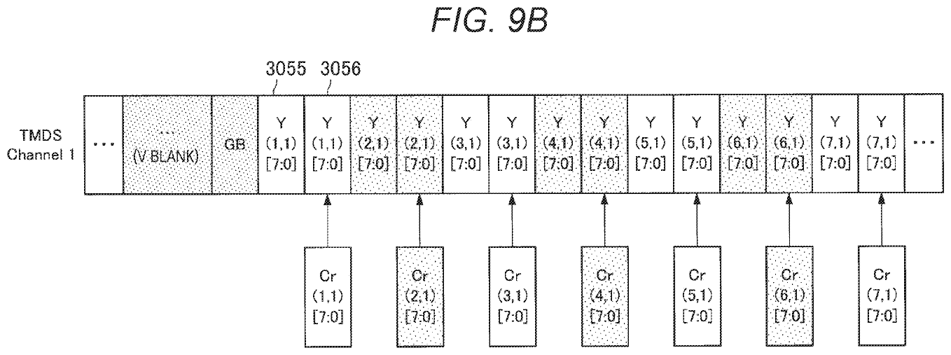

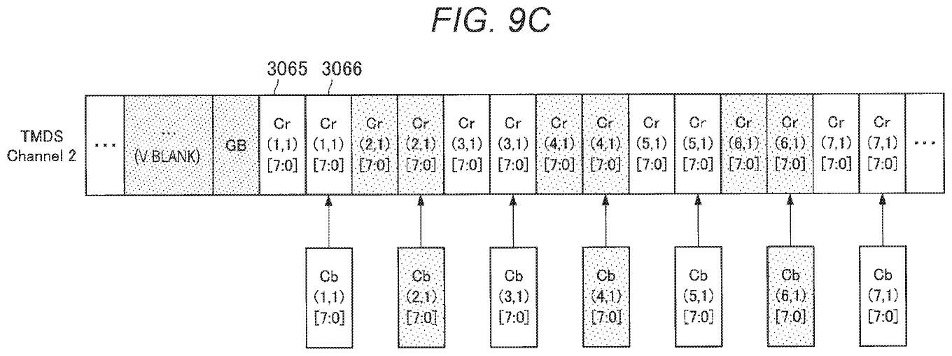

FIGS. 9A to 9C are diagrams illustrating an example in which transmittance data of each lane in a case where sub-data is duplication data is applied to the HDMI. In the present example, in the HDMI, data transmittance is performed on the transmittance path with Pixel Repetition is “2,” and data transmitted first is treated as the main data and data transmitted later is treated as the sub-data of data transmitted twice in a row in practice. In a case where data transmittance is performed in the HDMI, Cb information is transmitted in a TMDS Channel 0, Y information is transmitted in a TMDS Channel 1, and Cr information is transmitted in a TMDS Channel 2.

In FIG. 9A, in original HDMI standards, after Cb information 3045 of Pixel(1,1) is transmitted and then Cb information 3045 of Pixel(1,1) is re-transmitted as Cb information 3046 in the TMDS Channel 0. However, in the present embodiment, the Cb information of Pixel(1,1) is transmitted as the main data and then the Y information of Pixel(1,1) transmitted in the TMDS Channel 1 is transmitted as the sub-data.

Furthermore, as illustrated in FIG. 9B, in the present embodiment, similarly in the TMDS Channel 1, after the Y information 3055 of Pixel(1,1) is transmitted as the main data, instead of the Y information 3055 of Pixel(1,1) being re-transmitted as the Y information 3056, the Cr information of Pixel(1,1) transmitted in the TMDS Channel 2 is transmitted as the sub-data. Similarly in the TMDS Channel 2, after the Cr information 3065 of Pixel(1,1) is transmitted as the main data, instead of the Cr information 3065 of Pixel(1,1) being re-transmitted as the Cr information 3066, the Cb information of Pixel(1,1) transmitted in the TMDS Channel 0 is transmitted as the sub-data.

Note that such data transmittance can be achieved such that in the signal transmittance system 1A illustrated in FIG. 1, in a case where the transmission apparatus 10A is an HDMI transmitter and the reception apparatus 20A is an HDMI receiver, the video signal 101 (video input) and the image division unit 102 are operated corresponding to Color Depth 8 bits of the HDMI, 8-bit main data and 8-bit sub-data are set into 2-Byte continuous data in the duplication insertion unit 103A, the transmittance frame transmission units 104-1 to 104-M, the lanes 304-1 to 304-M, and the transmittance frame reception units 204-1 to 204-M are operated corresponding to Pixel Repetition 2 of the HDMI, 1 Byte (8 bits) is extracted from the Pixel Repetition 2-Byte continuous data in the extraction selection unit 203A, and the image combination unit 202 is operated corresponding to Color Depth 8 bits of the HDMI.

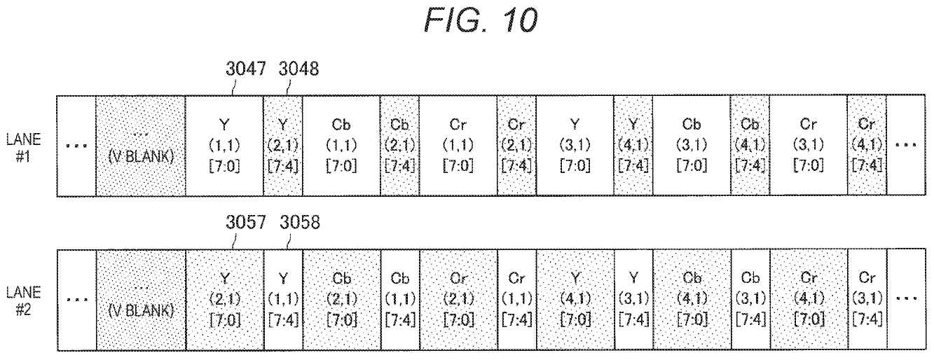

FIG. 10 is a diagram illustrating a first example of transmittance data of each lane in a case where the amount of data of sub-data is smaller than the amount of data of main data. In the present example, 4-bit sub-data is inserted with respect to 8-bit main data. As illustrated in FIG. 10, Y information 3047 of Pixel(1,1) is transmitted for 8 bits as the main data in the lane #1, and Y information 3057 of Pixel(2,1) is transmitted for 8 bits as the main data in the lane #2. Thereafter, Y information 3048 of Pixel(2,1) is transmitted for high-order 4 bits as the sub-data in the lane #1, and Y information of Pixel(1,1) is transmitted for high-order 4 bits as the sub-data in the lane #2.

In the present transmittance example, only data of high-order 4 bits of each element is input as the sub-data to the extraction selection unit 203A of the reception apparatus 20A. Therefore, low-order 4 bits corresponding to high-order 4 bits of each element input as the sub-data may be a fixed value, e.g., 0x0. Alternatively, in a case where the Pixel of the main data and the Pixel of the sub-data inserted into the main data in one lane are adjacent on a screen, low-order 4 bits of the main data can be used as the low-order 4 bits corresponding to the high-order 4 bits of each element input to the extraction selection unit 203A as the sub-data.

In the present example, in the reception apparatus 20A, in a case where the transmittance state of a certain lane is worse than the predetermined state, it is considered that the main data of the certain lane cannot completely be restored from the sub-data inserted into a different lane. However, because the main data in the certain lane is not entirely defective (because the original data in the certain lane is not entirely defective because of the sub-data), it is possible to ease the disturbance of an image, e.g., bit lacking. The present example, as an example, can be used in a case where the bandwidth of the transmittance path 30 is not sufficient to transmit the entire main data in a completely duplicate manner.

Note that such data transmittance can be achieved such that in the signal transmittance system 1A illustrated in FIG. 1, in a case where the transmission apparatus 10A is a DP transmitter and the reception apparatus 20A is a DP receiver, the video signal 101 (video input) and the image division unit 102 are operated corresponding to Color Depth 8 bits of the DP, 4-bit sub-data is inserted into 8-bit main data to form 12-bit data in the duplication insertion unit 103A, the transmittance frame transmission units 104-1 to 104-M, the lanes 304-1 to 304-M, and the transmittance frame reception units 204-1 to 204-M are operated corresponding to Color Depth 12 bits of the DP, 8 bits and 4 bits are extracted from the 12-bit data in the extraction selection unit 203A, and the image combination unit 202 is operated corresponding to Color Depth 8 bits of the DP.

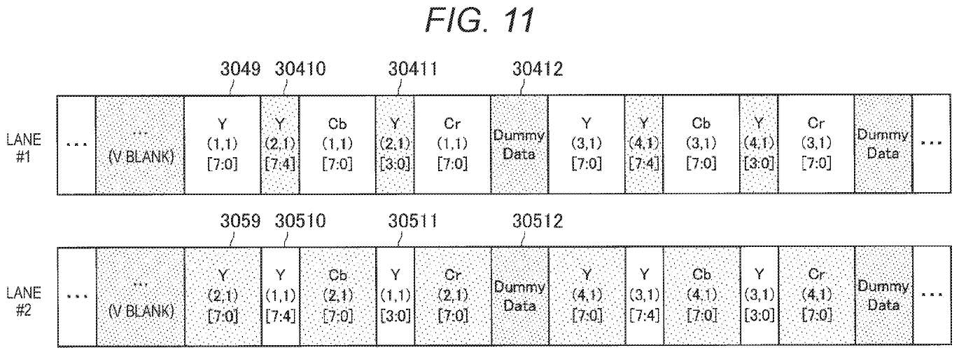

FIG. 11 is a diagram illustrating a second example of transmittance data of each lane in a case where the amount of data of sub-data is smaller than the amount of data of main data. In the present example, in a case where the form of pixel data is YCbCr444, only the Y information is inserted as the sub-data. Furthermore, the Pixel in which the Y information is inserted as the sub-data is adjacent to the Pixel of the main data. As illustrated in FIG. 11, Y information 3049 of Pixel(1,1) is transmitted for 8 bits as the main data in the lane #1, and Y information 3059 of Pixel(2,1) is transmitted for 8 bits as the main data in the lane #2.

Thereafter, Y information of Pixel(2,1) is transmitted for high-order 4 bits 30410 as the sub-data and Cb information of Pixel(1,1) is transmitted for 8 bits as the main data in the lane #1. Then, low-order 4 bits 30411 of the Y information of Pixel(2,1) are transmitted as the sub-data. Meanwhile, high-order 4 bits 30510 of the Y information of Pixel(1,1) is transmitted as the sub-data in the lane #2, and Cb information of Pixel(2,1) is transmitted for 8 bits as the main data. Then, low-order 4 bits 30511 of the Y information of Pixel(2,1) are transmitted as the sub-data.

Thereafter, in the lane #1, after the Cr information of the Pixel is transmitted for 8 bits, Dummy Data 30412 free of valid Data is transmitted for 4 bits. Similarly, in the lane #2, after the Cr information of the Pixel is transmitted for 8 bits, Dummy Data 30512 free of valid Data is transmitted for 4 bits. The Dummy Data is data for adjustment of Data transmittance intervals and may not be transmitted in a case where adjustment is not necessary.

In the present transmittance example, the Y information is input as the sub-data to the extraction selection unit 203A of the reception apparatus 20A. Then, as the Cr and Cb information of the Pixel of the sub-data, the Cr and Cb information (Cr and Cb information of the Pixel of the main data) of the Pixel adjacent to the Pixel of the sub-data is used.

In the present example, in the reception apparatus 20A, in a case where the transmittance state of a certain lane is worse than the predetermined state, it is considered that the main data of the certain lane cannot completely be restored from the sub-data inserted into a different lane. However, because the Y information of the main data transmitted in the certain lane can be restored, it is possible to ease the visual disturbance of an image.

Note that such data transmittance can be achieved such that in the signal transmittance system 1A illustrated in FIG. 1, in a case where the transmission apparatus 10A is a DP transmitter and the reception apparatus 20A is a DP receiver, the video signal 101 (video input) and the image division unit 102 are operated corresponding to Color Depth 8 bits of YCbCr444 of the DP, 4-bit sub-data is inserted into 8-bit main data and the Dummy Data is inserted in the duplication insertion unit 103A, the transmittance frame transmission units 104-1 to 104-M, the lanes 304-1 to 304-M, and the transmittance frame reception units 204-1 to 204-M are operated corresponding to Color Depth 12 bits of the DP, 8 bits and 4 bits are extracted from the 12-bit data in the extraction selection unit 203A, and the image combination unit 202 is operated corresponding to Color Depth 8 bits of the DP.

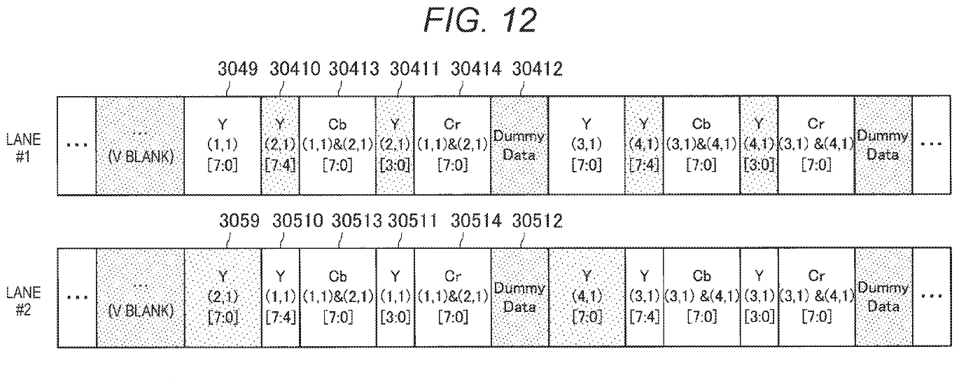

FIG. 12 is a diagram illustrating a third example of transmittance data of each lane in a case where the amount of data of sub-data is smaller than the amount of data of main data. In the present example, in a case where the form of pixel data is YCbCr422, the Y information is transmitted as the sub-data, because the Cb and Cr information is originally thinned between specific adjacent Pixels and transmitted as common information (the Cb and Cr information of adjacent two Pixels is transmitted only in one lane), the Cb and Cr information is transmitted in a duplicate manner as pixel data in each of both lanes (the Cb and Cr information of adjacent two Pixels is transmitted in each of both lanes).

The present example differs from the example illustrated in FIG. 11 in that in the example illustrated in FIG. 11, the Cb and Cr information is thinned between Pixel(1,1) and Pixel(2,1). However, in the present example, Cb information 30413 and 30513 of Pixel(1,1) and Pixel(2,1) is transmitted in a duplicate manner, and Cr information 30414 and 30514 of Pixel(1,1) and Pixel(2,1) is transmitted in a duplicate manner. Furthermore, in a case where the form of pixel data is YCbCr420, although the Cb and Cr information is thinned between adjacent 4 Pixels originally, the information is transmitted in a duplicate manner.

In the present example, in the reception apparatus 20A, in a case where the transmittance state of a certain lane is worse than the predetermined state, the main data of the certain lane can completely be restored from the sub-data inserted into a different lane.

Note that such data transmittance can be achieved such that in the signal transmittance system 1A illustrated in FIG. 1, in a case where the transmission apparatus 10A is a DP transmitter and the reception apparatus 20A is a DP receiver, the video signal 101 (video input) and the image division unit 102 are operated corresponding to Color Depth 8 bits of YCbCr422 or YCbCr420 of the DP, 4-bit sub-data is inserted into 8-bit main data and the Dummy Data is inserted in the duplication insertion unit 103A, the transmittance frame transmission units 104-1 to 104-M, the lanes 304-1 to 304-M, and the transmittance frame reception units 204-1 to 204-M are operated corresponding to Color Depth 12 bits of YCbCr444 of the DP, 8 bits and 4 bits are extracted from the 12-bit data in the extraction selection unit 203A, and the image combination unit 202 is operated corresponding to Color Depth 8 bits of the DP.

(1-5. Description of Effect)

As described above, according to the first embodiment of the present disclosure, the transmittance frame generation unit 1042 of the transmittance frame transmission unit 104-1 generates a first transmittance frame transmitted via the lane 304-1 on the basis of the divided signal #1 obtained through division of the video signal. Furthermore, the insertion unit 1035-2 of the duplication insertion unit 103A inserts restoration data based on at least a part of the divided signal #1 into the divided signal #2 obtained through division of the video signal. Then, the transmittance frame generation unit 1042 of the transmittance frame transmission unit 104-2 generates a second transmittance frame transmitted via the lane 304-2 on the basis of the divided signal #2 into which the restoration data has been inserted.

With such a configuration, even if the transmittance state of the lane 304-1 in which the divided signal #1 obtained through division of the video signal is transmitted is deteriorated, restoration data based on at least a part of the divided signal #1 is inserted into the divided signal #2 which is transmitted by the lane 304-2. Accordingly, when the restoration data is used in the reception apparatus 20A to restore at least a part of the divided signal #1, it is possible to further suppress the disturbance of a video displayed on a reception side.

### 2. Second Embodiment

Next, the second embodiment is described.

(2-1. Configuration of Signal Transmittance System)

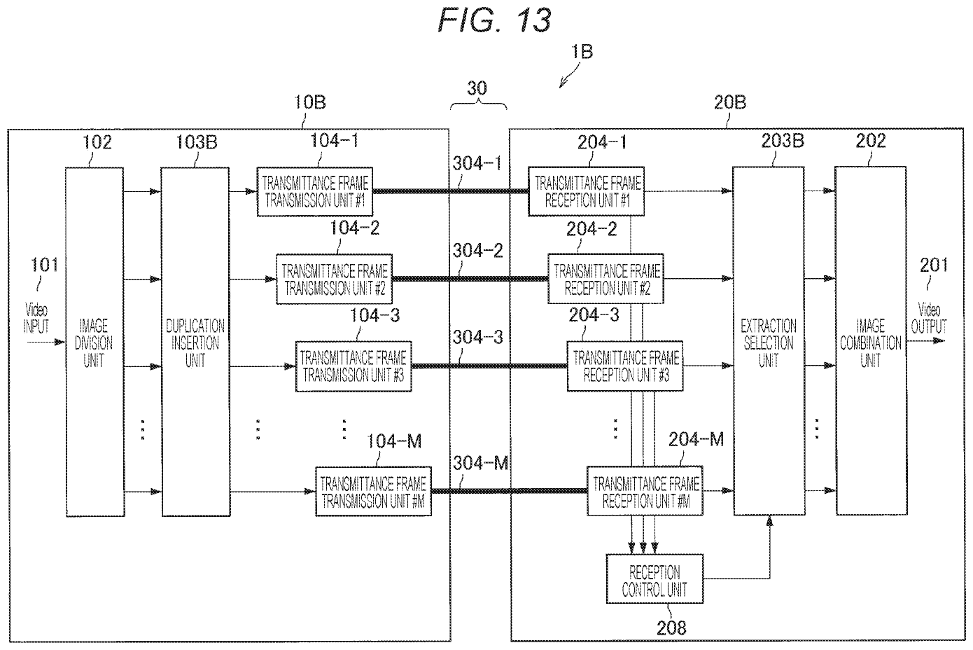

A configuration example of a signal transmittance system 1B according to the second embodiment is described. The second embodiment differs from the first embodiment such that a difference between the main data of a certain lane and the main data of a different lane is inserted as the sub-data of the certain lane. FIG. 13 is a diagram illustrating an example of a configuration of the signal transmittance system 1B according to the second embodiment. As illustrated in FIG. 13, the signal transmittance system 1B includes a transmission apparatus 10B and a reception apparatus 20B.

The transmission apparatus 10B according to the second embodiment mainly differs from the transmission apparatus 10A according to the first embodiment in that the transmission apparatus 10B includes a duplication insertion unit 103B instead of the duplication insertion unit 103A. Meanwhile, the reception apparatus 20B according to the second embodiment mainly differs from the reception apparatus 20A according to the first embodiment in that the reception apparatus 20B includes an extraction selection unit 203B instead of the extraction selection unit 203A. A configuration of the second embodiment that differs from that of the first embodiment is mainly described.

(2-2. Configuration of Transmission Apparatus)

Next, a configuration of the transmission apparatus 10B according to the second embodiment is described. A configuration of the duplication insertion unit 103B is mainly described below.

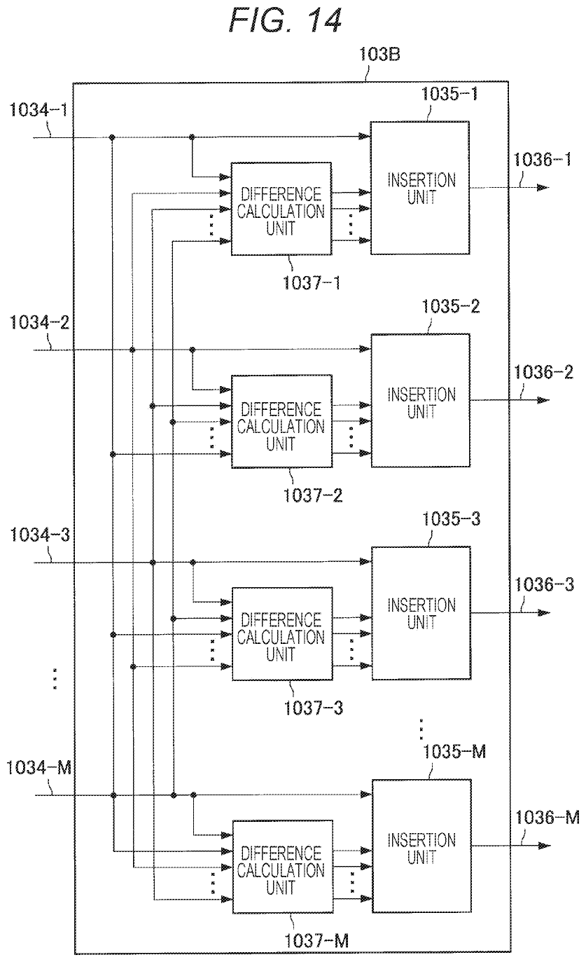

FIG. 14 is a diagram illustrating a configuration example of the duplication insertion unit 103B according to the second embodiment. As illustrated in FIG. 14, the duplication insertion unit 103B according to the second embodiment differs from the duplication insertion unit 103A according to the first embodiment in that the duplication insertion unit 103B includes difference calculation units 1037-1 to 1037-M. The difference calculation unit 1037-1 calculates a difference between the main data (divided signal #1) and at least some of the divided signals #2 to #M, and outputs the calculated difference to the insertion unit 1035-1 as the sub-data.

Similarly, each of the difference calculation units 1037-2 to 1037-M calculates a difference between the main data (divided signals #2 to #M) and at least some of the other divided signals, and outputs the calculated difference to a corresponding insertion unit (insertion units 1035-2 to 1035-M) as the sub-data. Note that the calculation of the difference by the difference calculation units 1037-1 to 1037-M is desirably performed between the Pixel of the main data and an adjacent Pixel.

(2-3. Configuration of Reception Apparatus)

Next, a configuration of the reception apparatus 20B according to the second embodiment is described. A configuration of the extraction selection unit 203B is mainly described below.

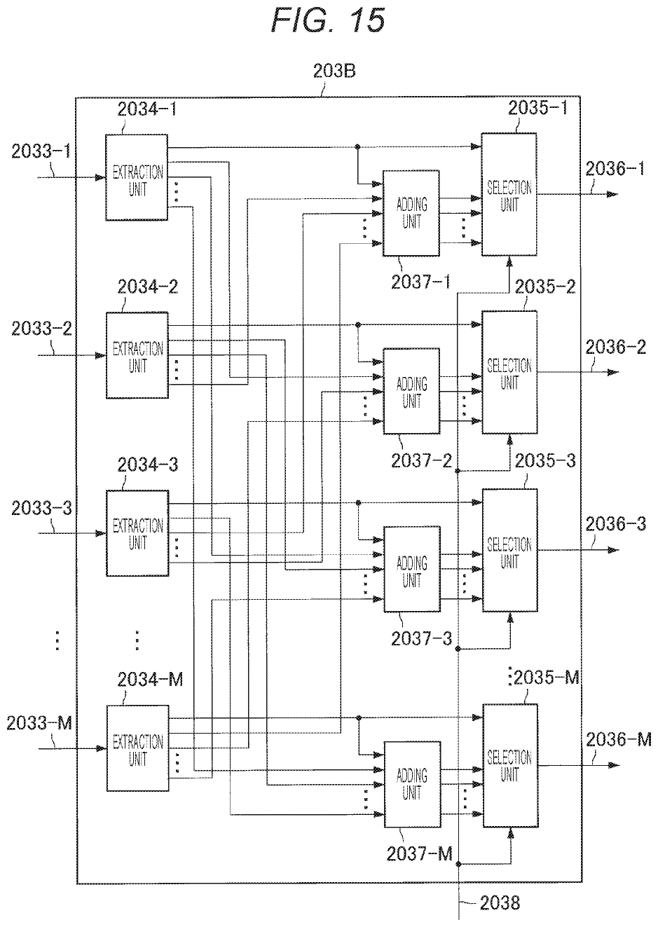

FIG. 15 is a diagram illustrating a configuration example of the extraction selection unit 203B according to the second embodiment. As illustrated in FIG. 15, the extraction selection unit 203B according to the second embodiment differs from the extraction selection unit 203A according to the first embodiment in that the extraction selection unit 203B includes adding units 2037-1 to 2037-M. The adding unit 2037-1 adds the main data (divided signal #1) and the sub-data (difference between the main data and the other divided signals), and outputs the addition results to the selection unit 2035-1 as at least some of the other divided signals (at least some of the divided signals #2 to #M).

Similarly, each of the adding units 2037-2 to 2037-M adds the main data (divided signals #2 to #M) and the sub-data (a difference between the main data and the other divided signals), and outputs the addition results to a corresponding selection unit (selection units 2035-1 to 2035-M) as at least some of the other divided signals. Note that the calculation of the difference by the adding units 2037-2 to 2037-M is desirably performed between the Pixel of the main data and an adjacent Pixel.

(2-4. Description of Operation)

Next, with reference to FIGS. 13 to 16, description is given of an example of an operation of the signal transmittance system 1B according to the second embodiment of the present disclosure. Specifically, description is given of an example of an operation in a case where the sub-data inserted into the main data is difference data.

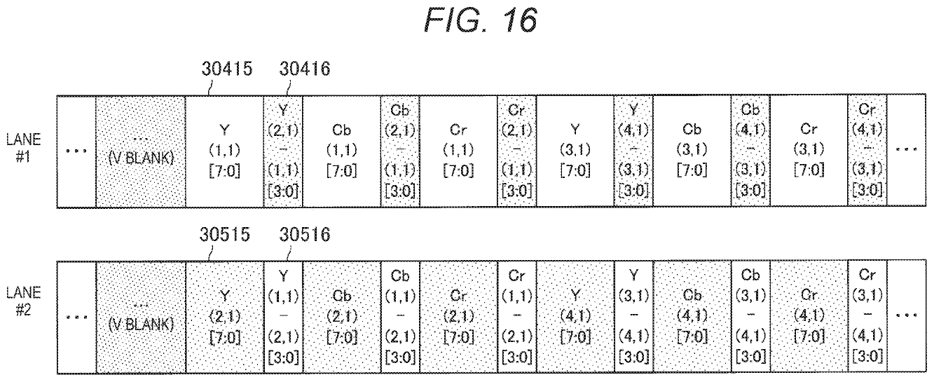

FIG. 16 is a diagram illustrating a transmittance data example of each lane in a case where the sub-data is difference data. Also in the example illustrated in FIG. 16, similar to the example illustrated in FIG. 10, 4-bit sub-data is inserted into 8-bit main data. Specifically, Y information 30415 of Pixel(1,1) is transmitted for 8 bits as the main data in the lane #1, and Y information 30515 of Pixel(2,1) is transmitted for 8 bits as the main data in the lane #2.

Thereafter, a difference obtained when the Y information of Pixel(1,1) is subtracted from the Y information of Pixel(2,1) is transmitted for 4 bits as the sub-data 30416 in the lane #1, and a difference obtained when the Y information of Pixel(2,1) is subtracted from the Y information of Pixel(1,1) is transmitted for 4 bits as the sub-data 30516 in the lane #2.

The present example, similar to the example illustrated in FIG. 10, can be used in a case where the bandwidth of the transmittance path 30 is not sufficient to transmit the entire main data in a completely duplicate manner. In the example illustrated in FIG. 10, low-order bits of the sub-data inserted into a different lane cannot be obtained. Therefore, in a case where the transmittance state of a certain lane is worse than the predetermined state, the main data of the certain lane cannot be completely restored from the sub-data inserted into the different lane, and a strip or a dot can appear on a screen. Meanwhile, in the present example, the possibility of restoring low-order bits from the difference data is increased, and it is possible to reduce the possibility that a strip or a dot appears on a screen.

Note that such data transmittance can be achieved such that in the signal transmittance system 1B illustrated in FIG. 13, in a case where the transmission apparatus 10B is a DP transmitter and the reception apparatus 20B is a DP receiver, the video signal 101 (video input) and the image division unit 102 are operated corresponding to Color Depth 8 bits of the DP, 4-bit sub-data is inserted into 8-bit main data to form 12-bit data in the duplication insertion unit 103B, the transmittance frame transmission units 104-1 to 104-M, the lanes 304-1 to 304-M, and the transmittance frame reception units 204-1 to 204-M are operated corresponding to Color Depth 12 bits of the DP, 8 bits and 4 bits are extracted from the 12-bit data in the extraction selection unit 203B, and the image combination unit 202 is operated corresponding to Color Depth 8 bits of the DP.

(2-5. Description of Effect)

As described above, in the second embodiment of the present disclosure, the restoration data based on at least a part of the divided signal #1 includes difference data between first pixel data included in the divided signal #1 and second pixel data included in the divided signal #2. Accordingly, when the difference data is used as the restoration data in the reception apparatus 20B, it is possible restore at least a part of the divided signal #1 more reliably. Therefore, it is possible to suppress the disturbance of a video displayed on a reception side more reliably.

### 3. Conclusion

As described above, according to the embodiment of the present disclosure, the transmittance frame generation unit 1042 of the transmittance frame transmission unit 104-1 generates a first transmittance frame transmitted via the lane 304-1 on the basis of the divided signal #1 obtained through division of the video signal. Furthermore, the insertion unit 1035-2 of the duplication insertion unit 103A inserts restoration data based on at least a part of the divided signal #1 into the divided signal #2 obtained through division of the video signal. Then, the transmittance frame generation unit 1042 of the transmittance frame transmission unit 104-2 generates a second transmittance frame transmitted via the lane 304-2 on the basis of the divided signal #2 into which the restoration data has been inserted.

With such a configuration, even if the transmittance state of the lane 304-1 in which the divided signal #1 obtained through division of the video signal is transmitted is deteriorated, restoration data based on at least a part of the divided signal #1 is inserted into the divided signal #2 which is transmitted by the lane 304-2. Accordingly, when the restoration data is used in the reception apparatus 20A to restore at least a part of the divided signal #1, it is possible to further suppress the disturbance of a video displayed on a reception side.

The preferred embodiment(s) of the present disclosure has/have been described above with reference to the accompanying drawings, while the technical scope of the present disclosure is not limited to the above examples. It is apparent that a person having normal knowledge in the technical field of the present disclosure may find various alterations and modifications within the scope of the technical idea stated in the claims, and it should be understood that they will naturally come under the technical scope of the present disclosure.

For example, the functional blocks of the transmission apparatus 10 may be mounted on different integrated circuits (ICs), and any combination may be mounted on the same IC. Furthermore, for example, the functional blocks of the reception apparatus 20 may be mounted on different ICs, and any combination may be mounted on the same IC.

Furthermore, the effects described in this specification are merely illustrative or exemplified effects, and are not limitative. That is, with or in place of the above effects, the technology according to the present disclosure may achieve other effects that are clear to those skilled in the art from the description of this specification.

Note that the configuration below falls within the technical scope of the present disclosure.

(1)

A transmission control apparatus including:

a first transmittance frame generation unit that generates a first transmittance frame transmitted via a first lane on the basis of a first divided signal obtained through division of a video signal;

an insertion unit that inserts restoration data based on at least a part of the first divided signal into a second divided signal obtained through division of the video signal; and

a second transmittance frame generation unit that generates a second transmittance frame transmitted via a second lane that is different from the first lane on the basis of the second divided signal into which the restoration data has been inserted.

(2)

The transmission control apparatus according to (1), in which the restoration data includes only a high-order bit of first pixel data included in the first divided signal.

(3)

The transmission control apparatus according to (1), in which the restoration data includes only Y information of first pixel data in a case where a form of the first pixel data included in the first divided signal is YCbCr444.

(4)

The transmission control apparatus according to (1), in which the restoration data includes CbCr information of first pixel data included in the first divided signal in addition to Y information of the first pixel data in a case where a form of the first pixel data included in the first divided signal is YCbCr422 or YCbCr420.

(5)

The transmission control apparatus according to (1), in which first pixel data included in the first divided signal and second pixel data included in the second divided signal are adjacent on a screen.

(6)

The transmission control apparatus according to any one of (1) to (5), in which the restoration data includes duplication data with respect to at least a part of the first divided signal.

(7)

The transmission control apparatus according to (1), in which the restoration data includes difference data between first pixel data included in the first divided signal and second pixel data included in the second divided signal.

(8)

A reception control apparatus including,

a signal acquisition unit that, in a case where a first transmittance frame including a first divided signal obtained through division of a video signal is transmitted via a first lane, and a second transmittance frame including a second divided signal into which restoration data based on at least a part of the first divided signal has been inserted is received via a second lane that is different from the first lane, acquires the second divided signal into which the restoration data has been inserted from the second transmittance frame.

(9)

The reception control apparatus according to (8), in which the reception control apparatus includes an image combination unit that combines the video signals on the basis of the first divided signal and the second divided signal, and the image combination unit uses the restoration data instead of at least a part of the first divided signal.

(10)

The reception control apparatus according to (9), in which the image combination unit uses the restoration data instead of at least a part of the first divided signal in a case where a transmittance state in the first lane is worse than a predetermined state.

(11)

The reception control apparatus according to (9) or (10), in which the restoration data includes only Y information of first pixel data in a case where a form of the first pixel data included in the first divided signal is YCbCr444, and the image combination unit uses Y information of the first pixel data included in the restoration data instead of the Y information of the first pixel data included in the first divided signal.

(12)

The reception control apparatus according to (11), in which the image combination unit uses CbCr information of second pixel data instead of the CbCr information of the first pixel data in a case where the first pixel data and the second pixel data included in the second divided signal are adjacent on a screen.

(13)

The reception control apparatus according to (9) or (10), in which the restoration data includes YCbCr information of first pixel data in a case where a form of the first pixel data included in the first divided signal is YCbCr422 or YCbCr420, and the image combination unit uses YCbCr information of the first pixel data included in the restoration data instead of the YCbCr information of the first pixel data included in the first divided signal.

(14)

The reception control apparatus according to (13), in which the restoration data includes CbCr information of second pixel data included in the first divided signal instead of the second divided signal, and the image combination unit uses the CbCr information of the second pixel data included in the restoration data instead of the CbCr information of the second pixel data included in the first divided signal in a case where a transmittance state in the first lane is worse than a predetermined state.

(15)

The reception control apparatus according to (9), in which first pixel data included in the first divided signal and second pixel data included in the second divided signal are adjacent on a screen.

(16)

The reception control apparatus according to (15), in which the reception control apparatus includes an image combination unit that uses the restoration data instead of a part of the first divided signal, and restores a different part of the first divided signal on the basis of the second pixel data that corresponds to the different part, in a case where the restoration data is based on a part of the first divided signal.

(17)

The reception control apparatus according to (8), in which the restoration data includes duplication data with respect to at least a part of the first divided signal, and the reception control apparatus includes an image combination unit that uses the duplication data instead of at least a part of the first divided signal.

(18)

The reception control apparatus according to (8), in which the restoration data includes difference data between first pixel data included in the first divided signal and second pixel data included in the second divided signal, and the reception control apparatus includes an image combination unit that uses an addition result of the difference data and the second pixel data instead of the first pixel data.

(19)

A transceiving control system including:

a transmission control apparatus including,

a first transmittance frame generation unit that generates a first transmittance frame transmitted via a first lane on the basis of a first divided signal obtained through division of a video signal,

an insertion unit that inserts restoration data based on at least a part of the first divided signal into a second divided signal obtained through division of the video signal, and

a second transmittance frame generation unit that generates a second transmittance frame transmitted via a second lane that is different from the first lane on the basis of the second divided signal into which the restoration data has been inserted; and

a reception control apparatus including:

a signal acquisition unit that acquires the second divided signal into which the restoration data has been inserted from the second transmittance frame.

(20)

The transceiving control system according to (19), in which the restoration data includes duplication data with respect to at least a part of the first divided signal.

### REFERENCE SIGNS LIST

(1A, 1B) Signal transmittance system
(10A, 10B) Transmission apparatus
101 Video signal
102 Image division unit
103A, 103B Duplication insertion unit
1035 Insertion unit
1037 Difference calculation unit
104 Transmittance frame transmission unit
1042 Transmittance frame generation unit
1043 Encode unit
1045 Transmission unit
(20A, 20B) Reception apparatus
202 Image combination unit
203A, 203B Extraction selection unit
2034 Extraction unit
2035 Selection unit
2037 Adding unit
204 Transmittance frame reception unit
2042 Signal acquisition unit
2043 Decode unit
2045 Reception unit
2047 Transmittance state measurement unit
208 Reception control unit
30 Transmittance path
304 Lane

1. A transmission control apparatus comprising:
a first transmittance frame generation unit that generates a first transmittance frame transmitted via a first lane on a basis of a first divided signal obtained through division of a video signal;
an insertion unit that inserts restoration data based on at least a part of the first divided signal into a second divided signal obtained through division of the video signal; and
a second transmittance frame generation unit that generates a second transmittance frame transmitted via a second lane that is different from the first lane on a basis of the second divided signal into which the restoration data has been inserted.

2. The transmission control apparatus according to claim 1, wherein the restoration data includes only a high-order bit of first pixel data included in the first divided signal.

3. The transmission control apparatus according to claim 1, wherein the restoration data includes only Y information of first pixel data in a case where a form of the first pixel data included in the first divided signal is YCbCr444.

4. The transmission control apparatus according to claim 1, wherein the restoration data includes CbCr information of first pixel data included in the first divided signal in addition to Y information of the first pixel data in a case where a form of the first pixel data included in the first divided signal is YCbCr422 or YCbCr420.

5. The transmission control apparatus according to claim 1, wherein first pixel data included in the first divided signal and second pixel data included in the second divided signal are adjacent on a screen.

6. The transmission control apparatus according to claim 1, wherein the restoration data includes duplication data with respect to at least a part of the first divided signal.

7. The transmission control apparatus according to claim 1, wherein the restoration data includes difference data between first pixel data included in the first divided signal and second pixel data included in the second divided signal.

8. A reception control apparatus comprising,
a signal acquisition unit that, in a case where a first transmittance frame including a first divided signal obtained through division of a video signal is transmitted via a first lane, and a second transmittance frame including a second divided signal into which restoration data based on at least a part of the first divided signal has been inserted is received via a second lane that is different from the first lane, acquires the second divided signal into which the restoration data has been inserted from the second transmittance frame.

9. The reception control apparatus according to claim 8, wherein the reception control apparatus includes an image combination unit that combines the video signals on a basis of the first divided signal and the second divided signal, and the image combination unit uses the restoration data instead of at least a part of the first divided signal.

10. The reception control apparatus according to claim 9, wherein the image combination unit uses the restoration data instead of at least a part of the first divided signal in a case where a transmittance state in the first lane is worse than a predetermined state.

11. The reception control apparatus according to claim 9, wherein the restoration data includes only Y information of first pixel data in a case where a form of the first pixel data included in the first divided signal is YCbCr444, and the image combination unit uses Y information of the first pixel data included in the restoration data instead of the Y information of the first pixel data included in the first divided signal.

12. The reception control apparatus according to claim 11, wherein the image combination unit uses CbCr information of second pixel data instead of the CbCr information of the first pixel data in a case where the first pixel data and the second pixel data included in the second divided signal are adjacent on a screen.

13. The reception control apparatus according to claim 9, wherein the restoration data includes YCbCr information of first pixel data in a case where a form of the first pixel data included in the first divided signal is YCbCr422 or YCbCr420, and the image combination unit uses YCbCr information of the first pixel data included in the restoration data instead of the YCbCr information of the first pixel data included in the first divided signal.

14. The reception control apparatus according to claim 13, wherein the restoration data includes CbCr information of second pixel data included in the first divided signal instead of the second divided signal, and the image combination unit uses the CbCr information of the second pixel data included in the restoration data instead of the CbCr information of the second pixel data included in the first divided signal in a case where a transmittance state in the first lane is worse than a predetermined state.

15. The reception control apparatus according to claim 9, wherein first pixel data included in the first divided signal and second pixel data included in the second divided signal are adjacent on a screen.

16. The reception control apparatus according to claim 15, wherein the reception control apparatus includes an image combination unit that uses the restoration data instead of a part of the first divided signal, and restores a different part of the first divided signal on a basis of the second pixel data that corresponds to the different part, in a case where the restoration data is based on a part of the first divided signal.

17. The reception control apparatus according to claim 8, wherein the restoration data includes duplication data with respect to at least a part of the first divided signal, and the reception control apparatus includes an image combination unit that uses the duplication data instead of at least a part of the first divided signal.

18. The reception control apparatus according to claim 8, wherein the restoration data includes difference data between first pixel data included in the first divided signal and second pixel data included in the second divided signal, and the reception control apparatus includes an image combination unit that uses an addition result of the difference data and the second pixel data instead of the first pixel data.

19. A transceiving control system comprising:
a transmission control apparatus including,
a first transmittance frame generation unit that generates a first transmittance frame transmitted via a first lane on a basis of a first divided signal obtained through division of a video signal,
an insertion unit that inserts restoration data based on at least a part of the first divided signal into a second divided signal obtained through division of the video signal, and
a second transmittance frame generation unit that generates a second transmittance frame transmitted via a second lane that is different from the first lane on a basis of the second divided signal into which the restoration data has been inserted; and
a reception control apparatus including:
a signal acquisition unit that acquires the second divided signal into which the restoration data has been inserted from the second transmittance frame.

20. The transceiving control system according to claim 19, wherein the restoration data includes duplication data with respect to at least a part of the first divided signal.
